(19) United States
(12) Patent Application Publication
(10) Pub. No.: US 2005/0039112 A1
(43) Pub. Date: Feb. 17, 2005

(54) System for inserting field data on a web-page and method thereof

(76) Inventor: Kwang-Chul Kim, Busan (KR)

Correspondence Address: Leopold Presser;Scully Scott Murphy & Presser, 400 Garden City Plaza, Garden City, NY, 11530, US

(21) Appl. No.: 10/343,664

(22) PCT Filed: May 29, 2001
(86) PCT No.: PCT/KR01/00901

(30) Foreign Application Priority Data
Aug. 3, 2000 (KR) 2000/45022

(51) Int. Cl. G06F 17/21

(52) U.S. Cl. 715/501.1

(57) ABSTRACT

The present invention relates to a web page from filling system and a method the same, which comprise: a user information data base being installed in a user computer accessible to Internet and having information about the forms required to be inputted on the web pages; a definition title having information about titles which are settable on common fields, and being linked to user information data base with respect to the common titles; a title data base dividing data of the titles according to form manes; a form analyzing robot analyzing the forms of the web pages, reading the pertinent titles, and substituting user information data base value of the definition for a field variable; and a tray engine driving a tray driving the form analyzing robot when performing the filling function.

### TECHNICAL FIELD

The present invention relates to a system for inserting field data on a web-page and a method thereof, and more particularly, to a system for inserting field data on a web-page and method thereof, which can provide a convenience in use to a user by analyzing field data on the web-page, such as applications for membership, bulletin boards, applications for career, settlements for shopping malls or the likes and inserting values into fields, which requires information input, in the corresponding field data if the user want.

### BACKGROUND ART

As all the necessary techniques related with an Internet are developed, various types of services are provided through WWW (World Wide Web). Gradually, an on-line medium, Internet, has settled as not only means for interchanging information to each other but also means for embodying electronic commerce between the government, companies and consumers.

The government, the companies and the consumers provide information while managing a homepage on Internet, embody the electronic commerce by managing shopping malls or embody a relay service such as career information.

In such Internet environment, a user connects to shopping mall sites, special information service sites or career information sites and performs member registration, writing on bulletin boards or application for career.

However, the user must input manually the same information of the user in every site in the same or similar manner. In case of writing on the bulletin boards, the user must repeatedly perform troublesome work of writing on all desired web sites by typing one by one.

Therefore, it is needed to develop tools for allowing the user to easily perform the member registration, the writing on the bulletin boards or the application for career.

### DISCLOSURE OF INVENTION

Therefore, it is an object of the present invention to provide a system for inserting field data on a web-page and a method thereof, which can allow a user to prepare field data required in a special web-page not by hand by analyzing field data on the connected web-page, if the user wants, and inserting field data in a field requiring information input.

It is another object of the present invention to provide a system for inserting field data on a web-pate and a method thereof, which can divide fields requiring information input as a definition of the title, substitute value of the information input and insert field data on the web-page when constructing a database of title applicable to the same fields and analyzing the field data of the web-page.

To achieve the above objects, the present invention provides a system for inserting field data on a web-page, the system being constructed in a user computer connectable to the Internet and including: a user information database having information of field data requiring information input in the web-page; a title database having data of titles settable to common fields, the title database having defined titles to link with the user information database in the common fields; a field data analyzing robot analyzing field data of the web page, which is activated after being connected to a web browser, reading the title and field, matching the title and the field in one-to-one, setting the defined title of the corresponding title while referring the title database, and substituting value of the user information database of the defined title for the field; and a tray engine actuating a tray, the tray engine performing a insertion function when a user selects the insertion function to be inserted into the tray.

Furthermore, the present invention provides a method for inserting field data on a web-page, the method comprising the steps of: performing an insertion function to fields requiring information input by using a tray, analyzing field data of the web-page of a web browser, which input an activated state, and reading a title and a field; referring the read title in a title database and defining the title; substituting user information database value of the defined title for value of the corresponding fields; and inputting the value of the substituted fields into the corresponding areas of the web-page field data.

### BRIEF DESCRIPTION OF THE DRAWINGS

Further objects and advantages of the invention can be more fully understood from the following detailed description taken in conjunction with the accompanying drawing in which:

FIG. 1 is a block diagram of a preferred embodiment of a system for inserting field data on a web-page according to the present invention;

FIG. 2 is a web-page of a bulletin board, as an example of field data;

FIG. 3 is a web-page of a member registration, as an example of field data;

FIG. 4 is an exemplary view of a tray window;

FIG. 5 is a flow chart for explaining a method for inserting field data on a web-page;

FIG. 6 is another exemplary view of the tray window; and

FIG. 7 is a flow chart for explaining a method for inserting field data on a web-page using the tray of FIG. 6.

### BEST MODE FOR CARRYING OUT THE INVENTION

The present invention will now be described in detail in connection with preferred embodiments with reference to the accompanying drawings. For reference, like reference characters designate corresponding parts throughout several views.

Referring to the drawings, a preferred embodiment of a system for inserting field data on a web-page and a method thereof will be described in detail.

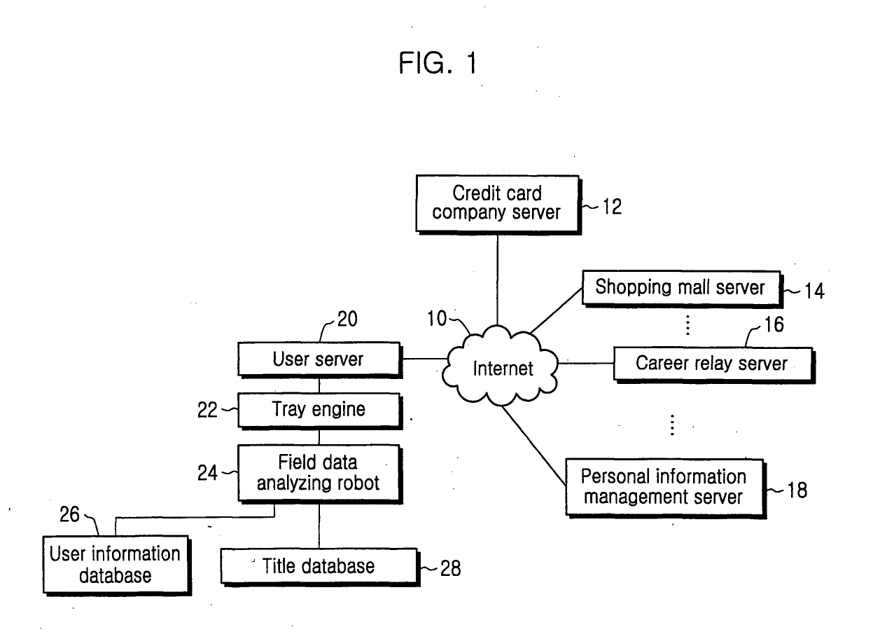

Referring to FIG. 1, a homepage, which is constructed and managed independently, is connected to an Internet. The homepage is connected with a credit card company server 12 managed by a credit card company, a shopping mall server 14 managed by a shopping mall, a career relay server 16 managed by a career relay company, and a personal information management server 18 performing an account management or a bookmark management.

The credit card company server 12 has a homepage including web-pages for embodying functions such as a request of credit card issue, an on-line use of the credit card, a change of member information and an inquiry of settled amount. The shopping mall server 14 has a homepage including web-pages for embodying functions such as a member registration, goods information for shopping, cost information, an inquiry of various information such as events, purchase of goods and payment. The career relay server 16 has a homepage including web-pages for embodying functions such as a member registration, registration for job finding or job offering, and career information. The personal information management server 18 has a homepage including web-pages for embodying functions such as an account registration, a bookmark registration and a tray supply.

A user connects to the Internet 10 through a user computer 20 having a communication module connectable to the Internet 10 and connects to a homepage managed by each server.

The user computer 20 downloads and installs a program for setting a tray provided by a specific server like the personal information management server 18.

When the program for the tray setting is installed, a tray engine 22 for actuating the tray is mounted in the user computer 20. The tray engine 22 has a field data analyzing robot 24. The field data analyzing robot 24 has a user information database 26 and a title database 28.

Here, the user information database 26 can be set in the personal information management server 18. In this case, if the user requires an insertion function, the user computer 20 inquires data of the user information database 26 through the Internet and applies value of the data into the insertion function.

The tray engine 22 outputs the tray having an information registration/change function, an insertion function and others at a start time of the user computer 20 or at a selection time of the tray operation, and outputs an auxiliary tray having detail functions according to item selection.

The field data analyzing robot 24 analyzes field data of the activated web-site of a web-site connected by a web browser of the user computer 20, construct the title database 28 having titles needed for field data analysis and the user information database 26 having user information for substituting for the field data.

The user connects a certain web-site connected to the Internet 10 by using the web browser operated by the user computer 20 and performs an information search or embodiment of electronic commerce.

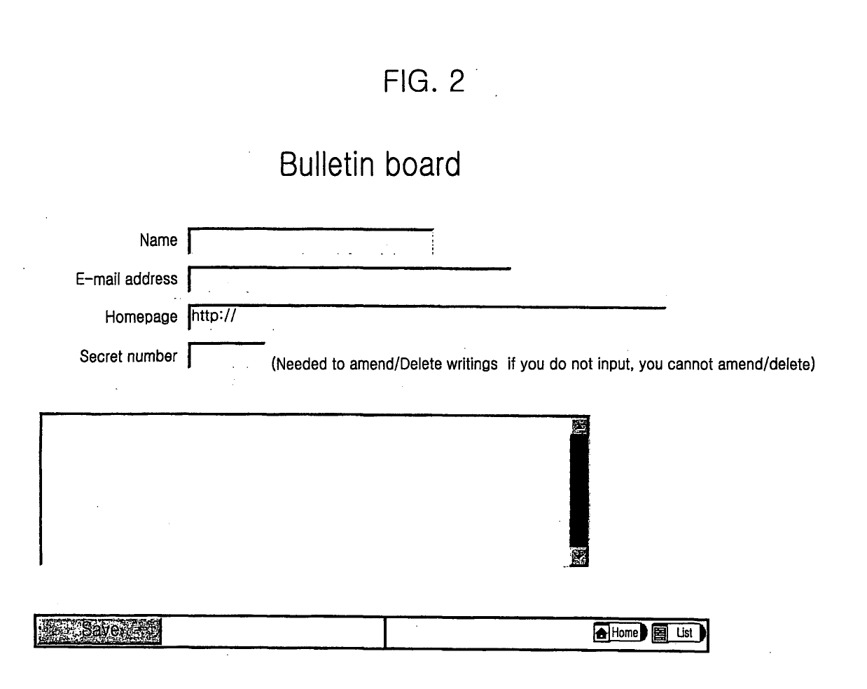

When the user wants to write the user's opinion, notice or information on the specific web-site, the user must input the corresponding information on a web-page having a bulletin board function requiring input of the user's name, e-mail address, homepage URL, secret number and contents, as shown in FIG. 2. Additionally, when the user tries to use services provided by the specific web-site, the user must input the corresponding information on the web-page for the member registration requiring the user's ID, secret number, name, resident registration number, date of birth and others.

For this, the user operates the tray created by the tray engine 22 and performs the insertion using the user information stored in the fields requiring the user information input.

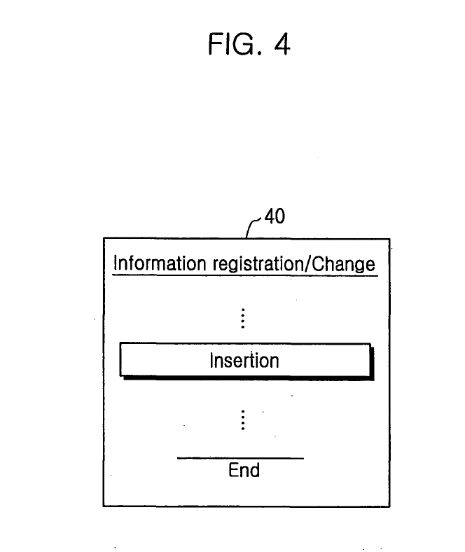

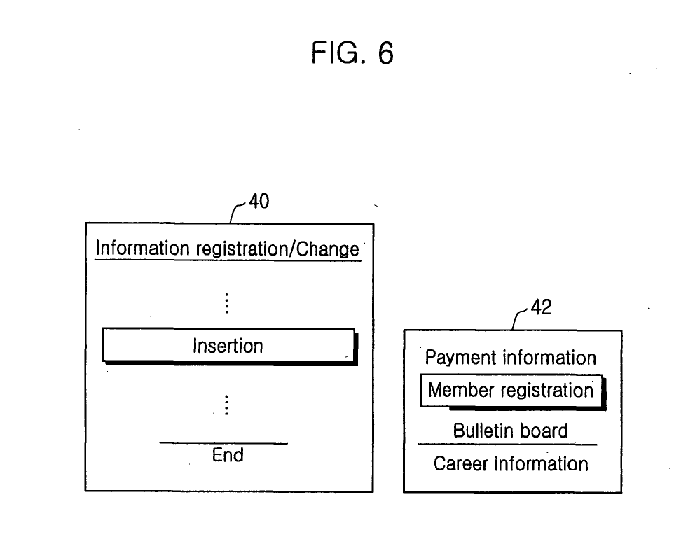

Concretely, as shown in FIG. 4 or FIG. 6, the tray can be provided. FIG. 4 shows a first embodiment for analyzing fields requiring the present field data and information input and performing the insertion function when the user selects the insertion function from menu of the tray. FIG. 6 shows a second embodiment for analyzing fields requiring input from the field data and performing the insertion function when the user selects the insertion function from the menu of the tray and selects a type of the field data for the insertion function.

As shown in FIG. 4, the tray 40 can provide an information registration/change function and the insertion function. When the user selects the information registration/change function, the tray engine 22 operates the field data analyzing robot 24 and outputs information stored in the user information database 26. When the user registers or changes the relevant information, the tray engine 22 operates the field data analyzing robot 24 and stores data of the information into the user information database 26.

The data stored in the user information database 26 is substituted for the fields defined through the analysis if there is a demand of the insertion function.

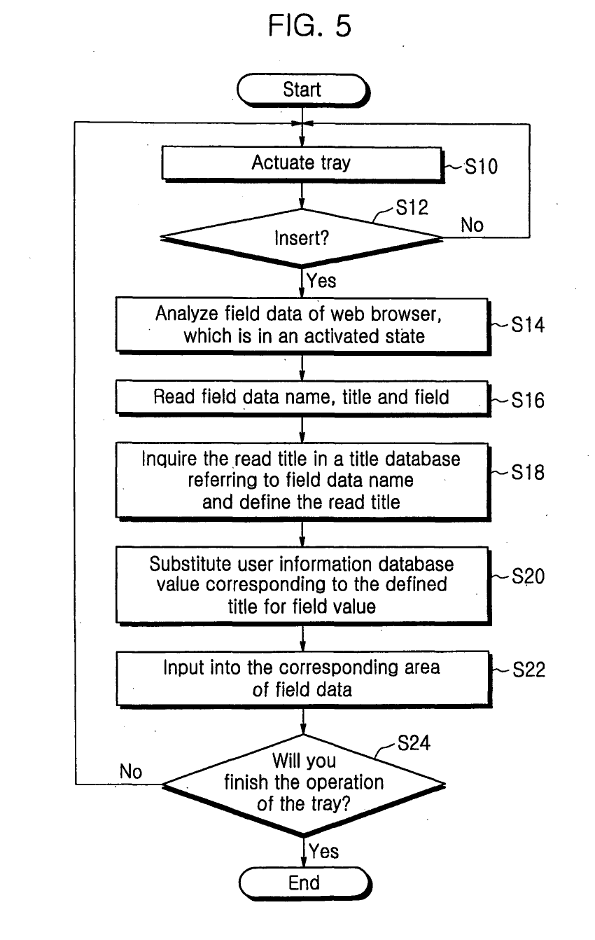

Referring to FIG. 5, an operation according to the selection of the insertion function will be described hereinafter.

When the tray 40 is operated (S10) and the user selects the insertion function of the tray 40 as shown in FIG. 4, the field data analyzing robot 24 analyzes the field data of the web browser, which is in an activated state (S14).

The web browser temporarily stores the web-page, which the user connects, and the web-page is prepared in HTML (Hyper Text Markup Language).

The HTML document can embody Hypertext, Hypermedia and Hyperlink and divide properties and sorts of data by using tag.

The HTML document for embodying the member registration and the career application is prepared in interlock with CGI (Common Gateway Interface), Perl (Practical Extraction and Report Language), Javascript or ASP (Active Server Page) to embody functions for registration of member information, writings on the bulletin board or contents for career application into the database, inquiring or changing them.

Titles and fields interlocking the CGI, Perl, Javascript or ASP are included in the HTML document to be input into the database, and field data name such as the “bulletin board” or the “member registration” indicating kind of the document is also included in the HTML document.

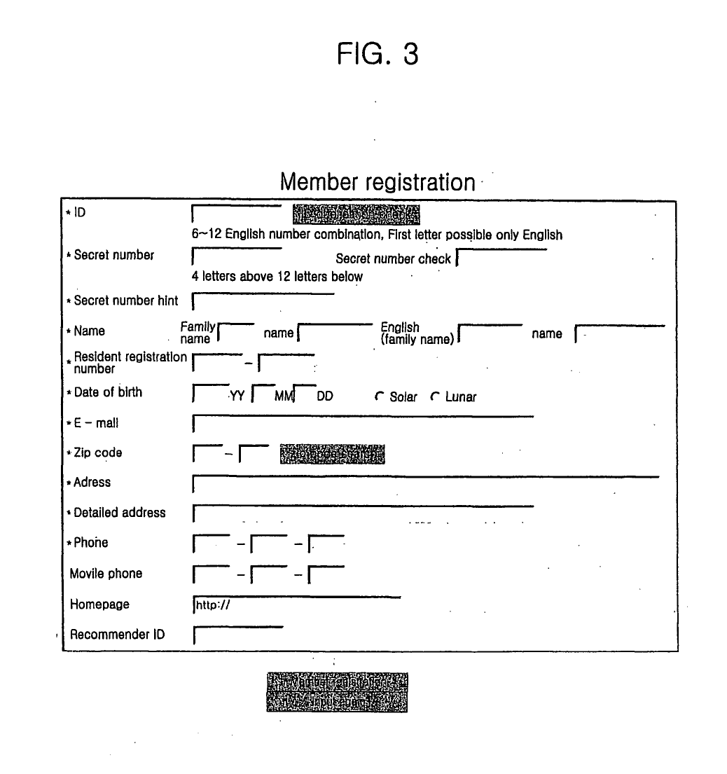

Referring to FIG. 3, the HTML document forming the web-page for member registration output to the web browser of the activated state is made by combination of source codes. The source codes includes codes for defining name, position, font and size of the field data name, codes for defining title, position, font and size of fields requiring input for the member registration, codes for defining fields corresponding to the titles, and codes for defining programs and databases interlocking and being linked to the fields.

For example, in FIG. 3, the field data name is ‘member registration’, and the titles are ‘ID’, ‘secrete number’, ‘hint of secrete number’, ‘recommender ID’ and so on.

The fields are codes assigned to blank areas, which are formed near to the titles, in one-to-one, and are source codes but not displayed on the web-pages. The fields are matched with the blank for each title in one-to-one. Concretely, the field of an “ID” blank is ‘_id’, the field of a ‘secret number’ blank is ‘_pass’, the field of a ‘hint of secret number’ blank is ‘_passhint’, the field of a ‘first name’ blank is ‘_fname’, the field of a ‘last name’ blank is ‘_lname’, and the field of a ‘resident registration number’ blank is ‘_pcode’. As described above, each blank may have its own field name.

The field data analyzing robot 24 inquires the read title in the title database 28 and defines what is the read title.

Here, the title database 28 divides the required titles by field data and constructs data. The title database 28 has various types settable as the titles and defined titles of the titles variously settable (hereinafter, called ‘defined titles’).

The titles required by field data are divided into title for inputting the member registration into the title database 28, title for writing on the bulletin board and title for inputting the career application.

Moreover, for an example of various types settable as the titles, in case of an account, the titles such as an account, an account ID and an ID can be set and can be registered into the database, and defined field names of titles similar to them can be set as ‘account’.

In the field data shown in FIG. 3, the field data analyzing robot 24 analyzes field data (S14) and reads the field data name as ‘member registration’, the title as ‘ID’ and the field as ‘_id’ (S16). After that, the field data analyzing robot 24 inquires the title of the member registration, ascertains that the defined title of ‘ID” is ‘account’ and defines the corresponding title as ‘account’ (S18).

If the read title is defined (S18), value of the user information database 26 corresponding to the defined title is substituted for field value (S20). Concretely, if value of the ‘account’ of the user information database 26 is set as ‘guest’, the ‘guest’ is substituted for the field ‘_id’ of the ‘ID’.

Such substitution is performed on the fields of each title and each field value is input in the corresponding area of the web-page of the web browser, which is in the activated state (S22).

After that, the field data analyzing robot 24 ascertains whether or not the operation of the tray is finished (S24), and then, keeps or finishes the operation state of the tray (S10).

Therefore, to perform the member registration in the web-page, the user can easily input data required for the ‘member registration’ by performing ‘insertion’ function by using the tray without manually inputting values into the blanks.

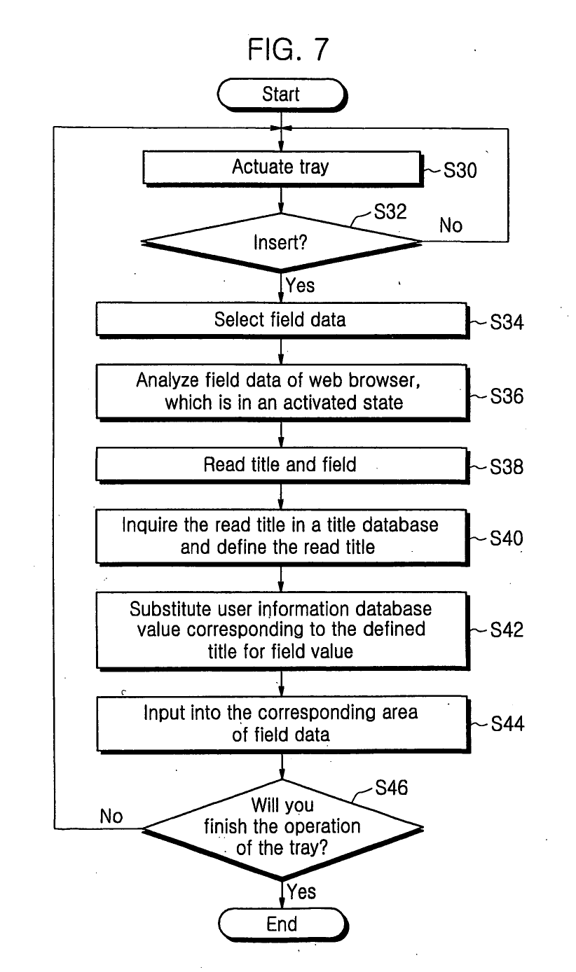

As shown in FIGS. 6 and 7, in the second preferred embodiment, a type of field data to be inserted is selected beforehand and analyzes the fields requiring information input in the field data to insert them. In the second embodiment shown in FIG. 6, the ‘information registration/change’ function of the tray 40 is the same as the first embodiment of FIGS. 4 and 5.

If the user selects the ‘insertion’ function of the tray 40, the auxiliary tray 42 is output. The auxiliary tray 42 has menu such as ‘account information’, ‘member registration’, ‘bulletin board’, and ‘career information’ to select types of field data for the ‘insertion’.

If the user selects the ‘member registration’ of the auxiliary tray, the field data analyzing robot 24 previously recognizes the field data name of the field data requiring the ‘insertion’.

Finally, the tray 40 of FIG. 6 is operated (S30), and the user selects the ‘insertion’ function (S12) and selects field data using the auxiliary tray 42 (S34).

The field data analyzing robot 24 previously recognizes the field data name according to the selected field data and analyzes the field data of the web browser of the activated state (S36).

After analyzing the field data of the web browser, the field data analyzing robot 24 reads the title and the field of the title (S38), inquires the read title to the title database and defines the read title (S40).

Here, the ‘field data name’ is defined as the ‘member registration’ by the user's selection using the auxiliary tray 42 and the field data analyzing robot 24 reads only the title and the field on the web-page.

That is, for an example, the field data analyzing robot 24 analyzes the field data (S36) and reads the title as ‘ID’ and the field as ‘_id’ (S38). After that, the field data analyzing robot 24 inquires the title database 28, ascertains that the defined title of ‘ID’ is ‘account’ and defines the title as ‘account’ (S40). At this time, the field data analyzing robot 24 first divides the title data of the previously fixed field data name, and then, defines the title.

If the read title is defined (S40), value of the user information database 26 corresponding to the defined title is substituted for value of the field (S42). Concretely, if the value of the ‘account’ field of the user information database 26 is set as ‘guest’, the ‘guest’ is substituted in the field code ‘_id’ of ‘ID’.

Such substitution is performed to the field of each title, and the value of each field is input in the corresponding area of the field data (S44).

After that, the field data analyzing robot 24 ascertains whether or not the operation of the tray is finished (S46), and then, keeps or finishes the operation state of the tray (S10).

Not shown in the drawings as an embodiment, but it is possible that a number of writings to be registered in the bulletin board are registered in the user information database 26, and the contents of the writings are inserted in the bulletin board by displaying in interlock when the ‘bulletin board’ of the auxiliary tray 42 is selected. Also, in this case, the field data analyzing robot 24 ascertains the title and the field and substitutes the corresponding contents for the field of the value of the defined title.

### INDUSTRIAL APPLICABILITY

Therefore, the present invention provides convenience in use by allowing the user to automatically insert required data into the web-page, which requires information input such as the bulletin board, the member registration, the career information, from the site connected through the Internet.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A system for inserting field data on a web-page constructed in a user computer connectable to an Internet, the system comprising:
a user information database having information of field data requiring information input in the web-page;
a title database having data of titles settable to common fields, the title database having defined titles linked with the user information database of the common fields;
a field data analyzing robot analyzing field data of the web page, which is activated after being connected to a web browser, reading the corresponding title and field, setting the defined title of the corresponding title while referring the title database, and substituting value of the user information database of the defined title for the field; and
a tray engine actuating a tray, the tray engine performing an insertion function when a user selects the insertion function to be inserted into the tray.

2. A method for inserting field data on a web-page to fields requiring information input by using a tray, the method comprising the steps of:
analyzing field data of the web-page of a web browser, which is in an activated state, and reading a title and a field;
referring the read title in a title database and defining the title;
substituting user information database value of the defined title for value of the corresponding fields; and
inputting the value of the substituted fields into the corresponding areas of the web-page field data.

3. The method as claimed in claim 2, wherein when a user selects field data name using menu of an auxiliary tray output by the tray, a field data analyzing robot divides the title of the field data name before inquiring the title in the title database.

4. The method as claimed in claim 2, wherein, in the step of analyzing the field data of the web-page, the field data analyzing robot reads the title and divides the title of the field data name before inquiring the title in the title database.
